(19) United States
(12) Patent Application Publication
(10) Pub. No.: US 2024/0177897 A1
(43) Pub. Date: May 30, 2024

(54) MAGNETIC POWDER, COMPOUND, MOLDED BODY, BONDED MAGNET, AND POWDER MAGNETIC CORE

(71) Applicant: Resonac Corporation, Tokyo (JP)

(72) Inventors: Kazumasa TAKEUCHI, Tokyo (JP); Arisa TAIRA, Tokyo (JP); Teruo ITOH, Tokyo (JP); Hideo MAEDA, Tokyo (JP); Chio ISHIHARA, Tokyo (JP)

(21) Appl. No.: 18/551,508

(22) PCT Filed: Apr. 15, 2022
(86) PCT No.: PCT/JP2022/017908

§ 371 Date: Sep. 20, 2023

(30) Foreign Application Priority Data
Apr. 16, 2021 (JP) 2021-069756

(51) Int. Cl. H01F 1/057; H01F 1/059; H01F 1/26; H01F 3/08

(52) U.S. Cl. CPC H01F 1/0578; H01F 1/059; H01F 1/26; H01F 3/08

(57) ABSTRACT

A magnetic powder includes: a plurality of magnetic particles including at least either one of a permanent magnet and a soft magnetic material; a first silicon compound covering at least a portion of the surfaces of the magnetic particles; and a second silicon compound covering at least a portion of the surfaces of the magnetic particles. The first silicon compound includes an alkyl group and silicon bonded to the alkyl group. The second silicon compound includes an alkyl chain, silicon bonded to one end of the alkyl chain, and a glycidyl group located at the other end of the alkyl chain. A number m of carbon atoms of the alkyl chain included in the second silicon compound is larger than a number n of carbon atoms of the alkyl group included in the first silicon compound.

### TECHNICAL FIELD

The present disclosure relates to a magnetic powder, a compound, a compact, a bonded magnet, and a dust core (pressed-powder core).

### BACKGROUND ART

Compounds obtained by combining a magnetic powder and a resin composition, and compacts obtained by compression molding of compounds, are used in various use applications according to the combination of the magnetic powder and the resin composition.

For example, a bonded magnet is a magnet obtained by molding a compound for bonded magnet into a predetermined shape under high pressure and curing a resin in the compound. The compound for bonded magnet is a mixture including a magnet powder, a resin (binder), a curing agent, a coupling agent, and the like. Since a compound is easily moldable, the degree of freedom for the shape and dimension of a bonded magnet is high compared to that of a sintered magnet. That is, bonded magnets having various shapes and dimensions, such as a thin ring-shaped magnet can be easily produced by molding of a compound. Furthermore, since a bonded magnet includes not only a magnet powder but also a binder, cracking and chipping of the bonded magnet are less likely to occur compared to a sintered magnet. Moreover, a compound for bonded magnet can be molded integrally with other members. Furthermore, since an insulating binder exists between magnet particles in a bonded magnet, the bonded magnet can have high electrical resistance. For the above-described reasons, bonded magnets are used in a wide variety of use applications. For example, bonded magnets are utilized in automobiles, general household electrical appliances, communication equipment, audio equipment, medical equipment, general industrial equipment, or the like.

Investigations have been conducted on using various resin compositions in a compound for bonded magnet in order to improve performances such as heat resistance of bonded magnets. For example, the following Patent Literature 1 discloses a binder including an epoxy resin and polybenzimidazole each at a fixed ratio, as resins increasing the mechanical strength of a rare earth bonded magnet at high temperatures. The following Patent Literature 2 discloses a compound having a dihydrobenzoxazine ring, a mixture of a compound having a dihydrobenzoxazine ring and an epoxy resin, or a mixture of a compound having a dihydrobenzoxazine ring and a phenol resin, as a binder for a rare earth bonded magnet. The following Patent Literature 3 discloses a polyamideimide resin as a binder for a rare earth bonded magnet. The following Patent Literature 4 discloses that a bonded magnet having a high density is produced by using a green compact that is less likely to generate cracks even when a raw material powder with a reduced amount of resin is molded under high pressure. The following Patent Literature 5 discloses that by producing a compact from magnetic particles (magnetic powder) covered with a compound having a silanol group or an organic phosphoric acid compound, the magnetic loss of the compact is reduced.

A dust core is obtained by compression molding of a compound including a soft magnetic powder and a resin composition (see the following Patent Literature 6). The degree of freedom for the shape and dimension of the dust core is high, the product yield of the dust core in the production process is high, and the material cost of the dust core can be reduced. From these advantages, dust cores are applied to a variety of soft magnetic component parts. For example, dust cores are used in inductors, transformers, reactors, thyristor valves, noise filters (EMI filters), choke coils, motor cores, rotors and yokes of motors for general household electrical appliances and industrial equipment, solenoid cores (fixed cores) for electromagnetic valves incorporated into electronically controlled fuel injection systems for diesel engines and gasoline engines, and the like.

### CITATION LIST

### Patent Literature

Patent Literature 1: Japanese Unexamined Patent Publication No. H8-273916

Patent Literature 2: Japanese Unexamined Patent Publication No. 2001-214054

Patent Literature 3: Japanese Unexamined Patent Publication No. 2004-31786

Patent Literature 4: Japanese Unexamined Patent Publication No. 2012-209484

Patent Literature 5: Japanese Unexamined Patent Publication No. 2019-104954

Patent Literature 6: Japanese Unexamined Patent Publication No. 2013-138159

Patent Literature 7: International Publication WO 2006/064794

Patent Literature 8: International Publication WO 2006/101117

Patent Literature 9: Specification of U.S. Pat. No. 4,802,931

Patent Literature 10: Japanese Unexamined Patent Publication No. 2019-48948

### SUMMARY OF INVENTION

### Technical Problem

It is an object of an aspect of the present invention to provide a magnetic powder that increase the density and mechanical strength of a compact including a magnetic powder and a resin composition, a compound including the magnetic powder, a compact including the compound, a bonded magnet including the compact, and a dust core including the compact.

### Solution to Problem

For example, the present invention relates to the following [1] to [21].

[1] A magnetic powder including:
a plurality of magnetic particles including at least either one of a permanent magnet and a soft magnetic material;
a first silicon compound covering at least a portion of surfaces of the magnetic particles; and
a second silicon compound covering at least a portion of the surfaces of the magnetic particles,
in which the first silicon compound includes an alkyl group and silicon bonded to the alkyl group,
the second silicon compound includes an alkyl chain, silicon bonded to one end of the alkyl chain, and a glycidyl group located on another end of the alkyl chain, and
a number m of carbon atoms of the alkyl chain included in the second silicon compound is larger than a number n of carbon atoms of the alkyl group included in the first silicon compound.

[2] The magnetic powder according to [1],
in which the silicon included in the first silicon compound is bonded to the surfaces of the magnetic particles through oxygen, and the silicon included in the second silicon compound is bonded to the surfaces of the magnetic particles through oxygen.

[3] The magnetic powder according to [1] or [2],
in which the number n of carbon atoms of the alkyl group included in the first silicon compound is 1 or more and 6 or less. [4] The magnetic powder according to any one of [1] to [3],
in which a plurality of the magnetic particles are at least one kind of permanent magnet selected from a Sm—Fe—N-based magnet and a Nd—Fe—B-based magnet.

[5] The magnetic powder according to any one of [1] to [3],
in which a plurality of the magnetic particles are at least one kind of soft magnetic material selected from a pure iron and an alloy including iron.

[6] A compound including:
the magnetic powder according to any one of [1] to [3]; and
a resin composition including a functional group capable of reacting with a glycidyl group.

[7] The compound according to [6],
in which the resin composition includes at least one resin selected from the group consisting of an epoxy resin, a phenol resin, a bismaleimide resin, a polyimide resin, a polyamide resin, and a polyamideimide resin, and at least a portion of the resin has a functional group capable of reacting with a glycidyl group.

[8] The compound according to [7],
in which the resin composition includes the epoxy resin and the phenol resin, and a ratio of a hydroxyl group equivalent of the phenol resin with respect to an epoxy equivalent of the epoxy resin is 1.0 or more and 1.4 or less.

[9] The compound according to [7] or [8],
in which the resin composition includes an epoxy resin and a compound having a functional group capable of reacting with the epoxy group.

[10] The compound according to [9],
in which the functional group capable of reacting with the epoxy group is an amino group.

[11] The compound according to [9] or [10],
in which a mass of the compound having the functional group capable of reacting with the epoxy group is 1 part by mass or more and 30 parts by mass or less with respect to 100 parts by mass of the epoxy resin.

[12] The compound according to any one of [7] to [11],
in which the resin composition includes the epoxy resin, and
at least a portion of the epoxy resin is a naphthalene type epoxy resin having a naphthalene structure.

[13] The compound according to [12],
in which the naphthalene type epoxy resin is at least one of a trifunctional epoxy resin and a tetrafunctional epoxy resin.

[14] The compound according to any one of [6] to [13],
in which a viscosity at 100° C. of the resin composition is 1 Pa·s or more and 50 Pa·s or less,
a viscosity at 50° ° C. of the resin composition after being heated at 100° ° C. for 30 minutes is represented by Vf,
a viscosity at 50° C. of the resin composition before being heated at 100° ° C. for 30 minutes is represented by Vi,
Vf is higher than Vi, and
the resin composition is a solid at 25° C.

The compound according to any one of [6] to [14],
in which a total mass of a plurality of the magnetic particles is represented by Mm,
a total mass of the first silicon compound, the second silicon compound, and the resin composition is represented by Mr, and Mm/Mr is 94/6 or more and 99/1 or less.

[16] The compound according to any one of [6] to [15],
in which a plurality of the magnetic particles are at least one kind of permanent magnet selected from a Sm—Fe—N-based magnet and a Nd—Fe—B-based magnet, and
the compound is used for a bonded magnet.

[17] The compound according to any one of [6] to [15],
in which a plurality of the magnetic particles are at least one soft magnetic material selected from a pure iron and an alloy including iron, and
the compound is used for a dust core.

[18] A compact for a bonded magnet,
including the compound according to [16].

[19] A compact for a dust core,
including the compound according to [17].

[20] A bonded magnet,
including the compact according to [18].

[21] A dust core,
including the compact according to [19].

### Advantageous Effects of Invention

According to an aspect of the present invention, a magnetic powder that increases the density and mechanical strength of a compact including a magnetic powder and a resin composition, a compound including the magnetic powder, a compact including the compound, a bonded magnet including the compact, and a dust core including the compact, are provided.

### BRIEF DESCRIPTION OF DRAWINGS

FIG. 1 is a schematic diagram illustrating an example of a first silicon compound covering the surface of a magnetic particle and an example of a second silicon compound covering the surface of a magnetic particle.

### DESCRIPTION OF EMBODIMENTS

Preferable embodiments of the present invention will be described below with reference to the drawings. In the drawings, similar constituent elements will be assigned with similar reference numerals. The present invention is not intended to be limited to the following embodiments.

### SUMMARY OF PRESENT EMBODIMENT

A magnetic powder according to the present embodiment includes a plurality of magnetic particles, a first silicon compound, and a second silicon compound. A compound according to the present embodiment includes the above-described magnetic powder and a resin composition including a functional group capable of reacting with a glycidyl group. The resin composition may be at least one of an uncured material and a semi-cured material. For example, the compound may be a powder. A compact according to the present embodiment includes the above-described compound. The term “compact” described below implicates an uncured compact, a semi-cured product of a compact, and a cured product of a compact.

Each of the plurality of magnetic particles includes at least either one of a permanent magnet and a soft magnetic material.

For example, the plurality of magnetic particles may be at least one permanent magnet (hard magnetic material) selected from a Sm—Fe—N-based magnet and a Nd—Fe—B-based magnet. When the plurality of magnetic particles are at least one permanent magnet selected from a Sm—Fe—N-based magnet and a Nd—Fe—B-based magnet, the compound may be used for a bonded magnet. A compact for a bonded magnet according to the present embodiment includes the above-described compound for a bond magnet. A bonded magnet according to the present embodiment includes the above-described compact for a bonded magnet.

For example, the plurality of magnetic particles may be at least one soft magnetic material selected from a pure iron and an alloy including iron. When the plurality of magnetic particles are at least one soft magnetic material selected from a pure iron and an alloy including iron, the compound may be used for a dust core. A compact for a dust core according to the present embodiment includes the above-described compound for a dust core. A dust core according to the present embodiment includes the above-described compact for a dust core.

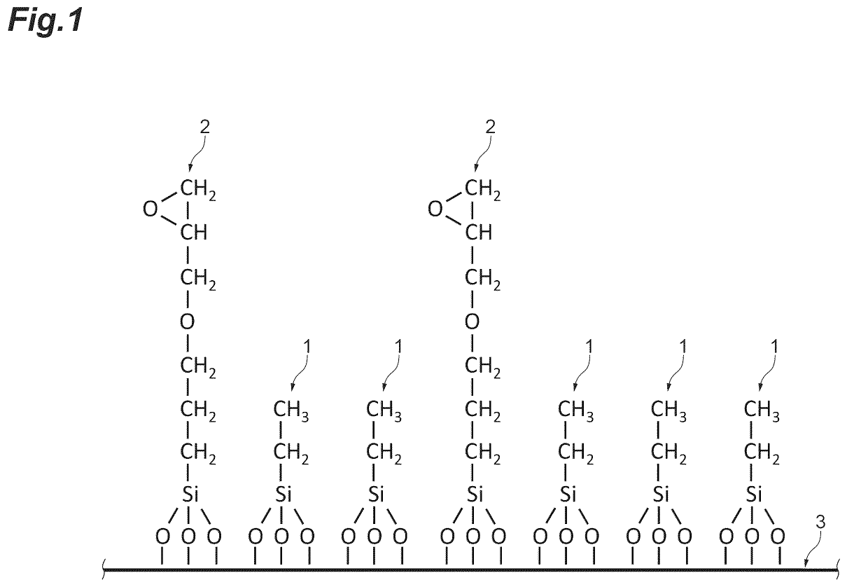

The first silicon compound includes an alkyl group and silicon (Si) bonded to the alkyl group. A methyl group constituting the alkyl group is located at an end of the first silicon compound. The number of carbon atoms constituting the alkyl group included in the first silicon compound is represented by n. n is a positive integer. For example, the alkyl group included in the first silicon compound may be a linear alkyl group represented by —CₙH₂ₙ₊₁. For example, the alkyl group included in the first silicon compound 1 shown in FIG. 1 is an ethyl group (—C₂H₅). The alkyl group included in the first silicon compound may be a branched alkyl group.

The second silicon compound includes an alkyl chain having a number m of carbon atoms, silicon (Si) bonded to one end of the alkyl chain, and a glycidyl group located at the other end of the alkyl chain. The number of carbon atoms constituting the alkyl chain included in the second silicon compound is represented by m. m is a positive integer. For example, the alkyl chain included in the second silicon compound may be a linear alkyl chain represented by —CₘH₂ₘ—. For example, the second silicon compound 2 shown in FIG. 1 includes —C₃H₆— (alkyl chain), Si bonded to one end of —C₃H₆—, and a glycidyl group bonded to the other end of —C₃H₆— through O.

In FIG. 1, the surface 3 of a magnetic particle is approximated as a flat surface; however, a portion or the entirety of the surface 3 of each magnetic particle may be a curved surface actually. Each of the first silicon compound and the second silicon compound covers at least a portion of the surface of each magnetic particle. The entirety of the surface 3 of each magnetic particle may be covered by the first silicon compounds and the second silicon compounds. For example, as shown in FIG. 1, silicon (Si) included in the first silicon compound 1 may be bonded to the surface 3 of a magnetic particle through oxygen (O). Silicon (Si) included in the second silicon compound 2 may be also bonded to the surface 3 of a magnetic particle through oxygen (O). A portion or all of the first silicon compounds may be bonded to the surface of the magnetic particle. A portion or all of the second silicon compounds may be bonded to the surface of the magnetic particle. Each of the first silicon compound and the second silicon compound may be bonded to the surface of the magnetic particle by the following reaction mechanism.

Prior to bonding to the surface of each magnetic particle, each of the first silicon compound and the second silicon compound may include silicon bonded to one or more and three or less alkoxy groups. As a result of hydrolysis of an alkoxy group, a silanol group may be formed at the end of the molecule of each of the first silicon compound and the second silicon compound. The silanol group of each of the first silicon compound and the second silicon compound may be coordinated to a hydroxyl group formed on the surface of each magnetic particle. By heating the silanol group coordinated to hydroxyl group, a dehydration reaction of the silanol group and the hydroxyl group may occur. Through the dehydration reaction, silicon of each of the first silicon compound and the second silicon compound may be bonded to the surfaces of the magnetic particle through oxygen.

The resin composition included in the compound may include at least one functional group selected from the group consisting of an epoxy group, a glycidyl group, a hydroxyl group, an amino group, an imide group, an amide group, a carboxy group, and an acid anhydride group (—(C═O)—O—(C═O)—) as a functional group capable of reacting with a glycidyl group. For example, the resin composition may include at least one resin selected from the group consisting of an epoxy resin, a phenol resin, a bismaleimide resin, a polyimide resin, a polyamide resin, and a polyamideimide resin, and at least some of these resins may have the functional group capable of reacting with the glycidyl group. Preferably, the resin composition may include a thermosetting resin. For example, the resin composition may include at least one thermosetting resin selected from the group consisting of an epoxy resin, a phenol resin, a bismaleimide resin, a polyimide resin, and a polyamideimide resin. The resin composition may include a plurality of kinds of thermosetting resins (for example, an epoxy resin and a phenol resin). A portion (for example, most) of the above-described functional groups included in the resin composition reacts during curing of the thermosetting resin (for example, a crosslinking reaction between thermosetting resin molecules), and the other portion of the functional groups included in the resin composition remains without reacting during curing of the thermosetting resin and then reacts with the glycidyl group included in the second compound. Due to the reaction and bonding between the glycidyl group in the second compound and the functional group in the resin composition, a structure represented by —CH(OH)—CH₂— may be formed. The resin composition may further include another resin (for example, a thermoplastic resin) in addition to the thermosetting resin. For example, a thermoplastic polyamide resin may be included in the resin composition together with the thermosetting resin.

The number m of carbon atoms of the alkyl chain included in the second silicon compound is larger than the number n of carbon atoms of the alkyl group included in the first silicon compound. Each of the first silicon compound and the second silicon compound covers the surface of each magnetic particle, and since m is larger than n, a compact formed from the compound has high density and high mechanical strength. The mechanism by which the density and mechanical strength of the compact heighten is as follows. However, the technical scope of the present invention is not limited to the following mechanism.

As the silicon of each of a plurality (a large number) of the first silicon compound molecules is bonded to the surface of the magnetic particle, a layer composed of the plurality (large number) of the first silicon compound molecules (first silicon compound layer) covers the surface of the magnetic particle. The outer surface of the first silicon compound layer is formed of methyl groups located at the end of the first silicon compound. Since a methyl group is less reactive than the functional group such as a glycidyl group of the second silicon compound, the surface free energy of the outer surface (surface of the first silicon compound layer) composed of methyl groups is lower than the surface free energy of the outer surface composed of the functional groups. Furthermore, since a methyl group is less reactive than the surface of the magnetic particle itself, the surface free energy of the outer surface (surface of the first silicon compound layer) composed of methyl groups is lower than the surface free energy of the surface of the magnetic particle itself. As a result, aggregation of the magnetic particles, friction between the magnetic particles, and friction between the magnetic particles and the resin composition are suppressed, the filling ratio of the magnetic powder in the compact formed by compression molding of the compound is increased, and the density of the compact is increased. Due to an increase in the density of the compact for a bonded magnet, the residual magnetic flux density of the bonded magnet is increased. Due to an increase in the density of the compact for a dust core, the magnetic permeability of the dust core is increased. Furthermore, as a result of suppressing aggregation of the magnetic particles, friction between the magnetic particles, and friction between the magnetic particles and the resin composition, each magnetic particle in a compact formed by compression molding in a magnetic field is likely to be oriented along the magnetic field. As a result, the residual magnetic flux density of the bonded magnet is increased.

Since the methyl group located at the end of the first silicon compound is less reactive, the first silicon compound is less likely to react with the above-described functional group included in the resin composition and is less likely to be chemically bonded to the resin composition. Therefore, when only the first silicon compounds between the first silicon compounds and the second silicon compounds cover the surfaces of the magnetic particles, the magnetic particles are less likely to be strongly bound through the resin composition, and the compact is less likely to have sufficiently high mechanical strength. However, since not only the first silicon compounds but also the second silicon compounds cover the surfaces of the magnetic particles, the glycidyl groups of the second silicon compounds react with the above-described functional groups included in the resin composition to be chemically bonded to the resin composition. Furthermore, since m is larger than n, the glycidyl group located at the end of the second silicon compound is farther from the surface of the magnetic particle than the methyl group located at the end of the first silicon compound. In other words, since m is larger than n, the glycidyl group located at the end of the second silicon compound is less likely to be embedded in the first silicon compound layer and is more likely to protrude from the surface of the first silicon compound layer. As a result, the glycidyl group in the second silicon compound is likely to react certainly with each functional group in the resin composition, and the second silicon compound is likely to be chemically bonded to the resin composition. Due to the chemical bonding between the second silicon compound and the resin composition, the magnetic particles are strongly bound to each other through the resin composition, and the compact can have sufficiently high mechanical strength.

(Details of First Silicon Compound and Second Silicon Compound)

The number n of carbon atoms of the alkyl group included in the first silicon compound may be 1 or more and 6 or less. As n is smaller, the glycidyl group located at the end of the second silicon compound is more likely to be far from the surface of the magnetic particle than the methyl group located at the end of the first compound. As a result, the glycidyl group of the second silicon compound easily reacts with the functional group included in the resin composition, and the mechanical strength of the compact is likely to be increased.

The number m of carbon atoms of the alkyl chain included in the second silicon compound may be an integer larger than n and is not particularly limited. For example, the number m of carbon atoms of the alkyl chain included in the second silicon compound may be 2 or more and 8 or less.

Each of the first silicon compound and the second silicon compound may be a silane coupling agent.

For example, the first silicon compound may be at least one selected from the group consisting of methyltrimethoxysilane (n=1, KBM-13 manufactured by Shin-Etsu Chemical Co., Ltd.), methyltriethoxysilane (n=1, KBE-13 manufactured by Shin-Etsu Chemical Co., Ltd.), dimethyldimethoxysilane (n=1, KBM-22 manufactured by Shin-Etsu Chemical Co., Ltd.), dimethyldiethoxysilane (n=1, KBE-22 manufactured by Shin-Etsu Chemical Co., Ltd.), n (normal)-propyltrimethoxysilane (n=3, KBM-3033 manufactured by Shin-Etsu Chemical Co., Ltd.), n(normal)-propyltriethoxysilane (n=3, KBE-3033 manufactured by Shin-Etsu Chemical Co., Ltd.), n(normal)-hexyltrimethoxysilane (n=6, KBM-3063 manufactured by Shin-Etsu Chemical Co., Ltd.), n(normal)-hexyltriethoxysilane (n=6, KBE-3063 manufactured by Shin-Etsu Chemical Co., Ltd., or Z-6586 manufactured by Dow Corning Toray Co., Ltd.), and compounds obtained by removing alkoxy group(s) from these. The value of n within the parentheses as described above is the number of carbon atoms of the alkyl group included in each of the first silicon compound. In the following description, the first silicon compound before being bonded to the surfaces of the magnetic particles is described as “first coupling agent”.

For example, the second silicon compound may be at least one selected from the group consisting of 2-(3,4-epoxycyclohexyl)ethyltrimethoxysilane (m=2, KBM-303 manufactured by Shin-Etsu Chemical Co., Ltd.), 3-glycidoxypropyltrimethoxysilane (m=3, KBM-403 manufactured by Shin-Etsu Chemical Co., Ltd.), 3-glycidoxypropylmethyldiethoxysilane (m=3, KBE-402 manufactured by Shin-Etsu Chemical Co., Ltd.), 3-glycidoxypropyltriethoxysilane (m=3, KBE-403 manufactured by Shin-Etsu Chemical Co., Ltd.), 8-glycidoxyoctyltrimethoxysilane (m=8, KBM-4803 manufactured by Shin-Etsu Chemical Co., Ltd.), 8-glycidoxyoctyltriethoxysilane (m=8, KBE-4803 manufactured by Shin-Etsu Chemical Co., Ltd.), and compounds obtained by removing alkoxy group(s) from these. The value of m within the parentheses as described above is the number of carbon atoms of the alkyl chain included in each of the second silicon compound. In the following description, the second silicon compound before being bonded to the surfaces of the magnetic particles is described as “second coupling agent”.

When the number n of carbon atoms of the alkyl group of each of a plurality of kinds of the first compounds is smaller than the number m of carbon atoms of the alkyl chain of the second compound, the magnetic powder may include a plurality of kinds of the first compounds. When the number m of carbon atoms of the alkyl chain of each of a plurality of kinds of the second compounds is larger than the number n of carbon atoms of the alkyl group of the first compound, the magnetic powder may include a plurality of kinds of the second compounds. When the number m of carbon atoms of the alkyl chain of each of a plurality of kinds of the second compounds is larger than the number n of carbon atoms of the alkyl group of a plurality of kinds of the first compounds, the magnetic powder may include a plurality of kinds of the first compounds and a plurality of kinds of the second compounds.

The total mass of the first silicon compounds included in the magnetic powder is represented by M1, the total mass of the second silicon compounds included in the magnetic powder is represented by M2, and M1/M2 may be 99/1 to 1/99, and preferably 90/10 to 80/20. Along with an increase in M1/M2, the density of the compact tends to increase. Along with a decrease in M1/M2, the mechanical strength of the compact tends to increase. When the M1/M2 is adjusted to be in the above-described range, high density and high mechanical strength are likely to be compatible.

The total mass M1 (unit: g) of the first silicon compounds required for covering the surfaces of the magnetic particles may be calculated from the specific surface area SAm (unit: m²/g) of the magnetic particles, the minimum covering area SA1 (unit: m²/g) of the first silicon compounds, and the total mass Mm (unit: g) of the magnetic particles themselves constituting the magnetic powder. SA1 is the minimum value of the surface areas of the magnetic particles that can be covered by 1 g of the first silicon compounds. For example, the mass M1 of the first silicon compounds required for covering the surfaces of the magnetic particles is calculated by the following Mathematical Formula 1.

The total mass M2 (unit: g) of the second silicon compounds required for covering the surfaces of the magnetic particles may be calculated from the specific surface area SAm (unit: m²/g) of the magnetic particles, the minimum covering area SA2 (unit: m²/g) of the second silicon compounds, and the total mass Mm (unit: g) of the magnetic particles themselves constituting the magnetic powder. SA2 is the minimum value of the surface areas of the magnetic particles that can be covered by 1 g of the second silicon compounds. For example, the mass M2 of the second silicon compound required for covering the surfaces of the magnetic particles is calculated by the following Mathematical Formula 2.

A in Mathematical Formula 1 is a positive real number. B in Mathematical Formula 1 is a positive real number. A+B is 1. R in Mathematical Formula 1 and Mathematical Formula 2 is a real number of 0.5 or more and 1 or less.

M1 (g)=R×SAm (m²/g)×A÷SA1 (m²/g)×Mm (g) (1)

M2 (g)=R×SAm (m²/g)×B÷SA2 (m²/g)×Mm (g) (2)

(Method for Producing Magnetic Powder)

A method (first production method) for producing a magnetic powder including a first silicon compound and a second silicon compound may include a step of bringing a first coupling agent and a second coupling agent into direct contact with a raw material powder composed only of a plurality of magnetic particles, and mixing the first coupling agent, the second coupling agent, and the raw material powder.

A method (second production method) for producing a magnetic powder including a first silicon compound and a second silicon compound may include: a step of preparing a solution of a first coupling agent and a second coupling agent; a step of mixing a raw material powder composed only of a plurality of magnetic particles with the above-described solution; and a step of distilling off the solvent from the solution including the raw material powder. The solvent used for the preparation of the solution of the first coupling agent and the second coupling agent may be, for example, at least one solvent selected from the group consisting of water, methanol, and ethanol.

In both the first production method and the second production method, it is preferable to leave the mixture of the first coupling agent, the second coupling agent, and the raw material powder for a sufficient time (for example, 48 hours) and then dry the mixture. The mixture may be dried at 100° ° C. to 120° C. The mixture may be dried for a sufficient time (for example, 2 hours or longer). By drying the mixture, a dehydration condensation reaction between a hydroxyl group on the surfaces of the magnetic powder and a silanol group of each coupling agent easily occurs, and each coupling agent is easily bonded to the surfaces of the magnetic particles. When the drying temperature is lower than 100° C., the dehydration condensation reaction is not likely to proceed sufficiently, and water produced by the dehydration condensation reaction is not removed sufficiently. When the drying temperature is 120° C. or higher, there is a possibility that the magnetic particles may be oxidized. When the drying temperature is 200° C. or higher, there is a possibility that the magnetic characteristics of the magnetic particles may be impaired depending on the type of the magnetic particles.

(Details of Magnetic Particles)

As described above, the magnetic particles include at least either one of a permanent magnet and a soft magnetic material. Magnetic particles including a permanent magnet are described as magnet particles or magnet powder. The magnetic particles may be composed only of a permanent magnet. Magnetic particles including a soft magnetic material are described as soft magnetic particles or soft magnetic powder. The magnetic particles may be composed only of a soft magnetic material.

The magnetic particles may be, for example, particles consisting of at least one selected from the group consisting of a pure metal, an alloy, and a metal compound. The alloy may include at least one composition selected from the group consisting of a solid solution, a eutectic, and an intermetallic compound. The metal compound may be, for example, an oxide such as a ferrite. The ferrite may be, for example, at least one ferrite selected from the group consisting of spinel ferrite, hexagonal ferrite, and garnet ferrite. The ferrite may be a hard ferrite (permanent magnet) or a soft ferrite (soft magnetic material). The magnetic particles may include one kind of metal element or a plurality of kinds of metal elements. The metal element included in the magnetic particles may be, for example, at least one element selected from the group consisting of a base metal element, a noble metal element, a transition metal element, and a rare earth element. The metal element may be, for example, at least one selected from the group consisting of iron (Fe), copper (Cu), titanium (Ti), manganese (Mn), cobalt (Co), nickel (Ni), zinc (Zn), aluminum (Al), tin (Sn), chromium (Cr), barium (Ba), strontium (Sr), lead (Pb), silver (Ag), praseodymium (Pr), neodymium (Nd), samarium (Sm), and dysprosium (Dy). The magnetic particles may also include an element other than the metal element. For example, the magnetic particles may include at least one element selected from the group consisting of nitrogen (N), oxygen (O), boron (B), and silicon (Si).

The permanent magnet may be, for example, at least one magnet selected from the group consisting of a samarium-iron-nitrogen (Sm—Fe—N)-based magnet, a neodymium-iron-boron (Nd—Fe—B)-based magnet, a samarium-cobalt (Sm—Co)-based magnet, an iron-cobalt (Fe—Co)-based magnet, an alnico (Al—Ni—Co) alloy-based magnet, and a ferrite-based magnet. The Sm—Fe—N-based magnet may be, for example, a magnet including Sm₂Fe₁₇N₃ as a main phase. The Nd—Fe—B-based magnet may be, for example, a magnet including Nd₂Fe₁₄B as a main phase. The Sm—Fe—N-based magnet can be produced from a relatively inexpensive raw material. The Sm—Fe—N-based magnet has an axis of easy magnetization, and an anisotropic magnet produced from a magnet powder including a Sm—Fe—N-based magnet has excellent magnetic characteristics. However, since the Sm—Fe—N-based magnet is easily decomposed at a high temperature (near 500° C.), it is difficult to sinter a magnet powder including the Sm—Fe—N-based magnet. Therefore, the Sm—Fe—N-based magnet is easily applicable to products such as a motor, as a bonded magnet.

The shape of the magnet particles may be, for example, an approximate sphere or flat. For example, the aspect ratio (short axis/long axis) of flat magnet particles formed from a Sm—Fe—N-based magnet may be 0.3 or less. The shape of the magnet particles may be distorted (non-uniform). When the shape of the magnet particles is flat, the magnet particles are likely to be laminated in an orderly manner such that a plurality of flat magnet particles are in close contact with each other, within a compact formed by compression molding of a magnet powder. As a result, voids between the magnet particles and resin pools are less likely to be formed, and the filling ratio of the magnet powder in a compact and a bonded magnet is likely to increase.

The average particle size of the magnet particles formed from a Nd—Fe—B-based magnet may be preferably 30 μm or more and 200 μm or less, and more preferably 50 μm or more and 100 μm or less. The average particle size of the magnet particles formed from a Sm—Fe—N-based magnet may be preferably 1 μm or more and 50 μm or less, and more preferably 2 μm or more and 10 μm or less. When the average particle size of the magnet particles is in the above-described range, the density and mechanical strength of the compact are likely to increase.

A method for producing a magnet powder is not limited. For example, a method for producing a magnet powder formed from a Sm—Fe—N-based magnet may include: a step of forming an alloy powder formed from Sm and Fe according to a mechanical alloying method; and a step of heating the alloy powder in nitrogen gas. The magnet powder may be produced by a rapid solidification method. In the rapid solidification method, a molten magnet alloy is supplied onto the surface of a rotating water-cooled roll to be solidified. A magnet powder is obtained by pulverizing the solidified magnet alloy. Furthermore, a magnet powder may also be produced by an HDDR (Hydrogenation Disproportionation Desorption Recombination) method.

As the magnet powder formed from a Sm—Fe—N-based magnet, for example, a non-pulverized powder (spherical-shaped magnet powder) obtainable by a buildup processing method of NICHIA CORPORATION may be used. The surfaces of magnet particles formed from a Sm—Fe—N-based magnet may be covered with a film of an inorganic substance by a surface treatment of the magnet particles constituting the magnet powder formed from a Sm—Fe—N-based magnet. For example, the film of an inorganic substance may include a phosphoric acid salt or a silica-based compound. As the magnet powder formed from a Nd—Fe—B-based magnet, for example, Ti-containing nanocomposites described in International Publication WO 2006/064794 and International Publication WO 2006/101117, and a magnet powder described in the specification of U.S. Pat. No. 4,802,931 may be used.

The soft magnetic material may be, for example, at least one metal selected from the group consisting of a pure iron and an alloy including iron. The alloy including iron may be, for example, at least one alloy selected from the group consisting of an Fe—Cr-based alloy (stainless steel), an Fe—Ni—Cr-based alloy (stainless steel), an Fe—Si-based alloy, an Fe—Si—Al-based alloy (Sendust), an Fe—Ni-based alloy (Permalloy), an Fe—Cu—Ni-based alloy (Permalloy), an Fe—Co-based alloy (Permendur), an Fe—Cr—Si-based alloy (electromagnetic stainless steel), and an Fe—Ni—Mn—C-based alloy (Invar). The soft magnetic material may be amorphous. The soft magnetic powder may be at least either one of an amorphous iron powder and a carbonyl iron powder. The soft magnetic material may be an Fe-based amorphous alloy. As a commercially available product of a soft magnetic powder consisting of an Fe-based amorphous alloy, for example, at least one selected from the group consisting of AW2-08, KUAMET-6B2 (these are trade names of products manufactured by EPSON ATMIX Corporation), DAP MS3, DAP MS7, DAP MSA10, DAP PB, DAP PC, DAP MKV49, DAP 410L, DAP 430L, DAP HYB series (these are trade names of products manufactured by Daido Steel Co., Ltd.), MH45D, MH28D, MH25D, and MH20D (these are trade names of products manufactured by Kobe Steel, Ltd.) may be used.

The shape of the soft magnetic particles is not particularly limited. The soft magnetic particles may be, for example, flat, spherical-shaped, or needle-shaped. The average particle size of the soft magnetic particles may be, for example, 60 μm or more and 150 μm or less. When the average particle size of the soft magnetic is in the above-described range, the density and mechanical strength of the compact are likely to increase.

The magnetic powder may include one kind of magnetic particles or may include a plurality of kinds of magnetic particles. The magnetic powder may include a plurality of kinds of magnetic particles having different average particle sizes or different median diameters (D50). The particle size of the magnetic particles may be calculated based on the weight measurement of the magnetic particles by sieving. The particle size of the magnetic particles may be measured by a laser diffraction type particle size distribution analyzer. The compound may further include an inorganic filler (for example, silica (SiO₂) particles) in addition to the above-described magnetic powder.

(Details of Resin Composition)

The resin composition functions as a binder that binds together the individual magnetic particles constituting the magnetic powder to each other and gives mechanical strength to a compact formed from the compound. For example, when a compound is molded under high pressure by using a mold, the resin composition fills the spaces between the magnetic particles and binds the magnetic particles to each other. Then, by curing the resin composition in the compact, the cured resin composition binds the magnetic particles together more strongly, and a compact having high mechanical strength is obtained.

The resin composition may include an epoxy resin. An epoxy resin has excellent fluidity among thermosetting resins. The epoxy resin may be, for example, a resin having two or more epoxy groups in one molecule. The epoxy equivalent of the epoxy resin is preferably 230 or less. By using an epoxy resin having an epoxy equivalent of 230 or less, the number of hydroxyl groups (OH groups) per unit mass of a compound produced by a reaction between a phenol resin as a curing agent increases. As a result, the mechanical strength of a compact produced by curing of the compound is improved. As the number of hydroxyl groups per unit mass of the compound increases, the corrosion resistance of a compact (for example, a bonded magnet) in hydrophobic oil is improved.

For example, the epoxy resin may be at least one selected from the group consisting of a biphenyl type epoxy resin, a stilbene type epoxy resin, a diphenylmethane type epoxy resin, a sulfur atom-containing type epoxy resin, a novolac type epoxy resin, a dicyclopentadiene type epoxy resin, a salicylaldehyde type epoxy resin, a copolymerized type epoxy resin of naphthols and phenols, an epoxide of an aralkyl type phenol resin, a bisphenol type epoxy resin, a glycidyl ether type epoxy resin of alcohols, a glycidyl ether type epoxy resin of para-xylylene- and/or meta-xylylene-modified phenol resin, a glycidyl ether type epoxy resin of a terpene-modified phenol resin, a cyclopentadiene type epoxy resin, a glycidyl ether type epoxy resin of a polycyclic aromatic ring-modified phenol resin, a glycidyl ether type epoxy resin of a naphthalene ring-containing phenol resin, a glycidyl ester type epoxy resin, a glycidyl type or methylglycidyl type epoxy resin, an alicyclic type epoxy resin, a halogenated phenol novolac type epoxy resin, an ortho-cresol novolac type epoxy resin, a hydroquinone type epoxy resin, a trimethylolpropane type epoxy resin, and a linear aliphatic epoxy resin obtainable by oxidizing an olefin bond with a peracid such as peracetic acid.

At least a portion of the epoxy resin included in the resin composition may be a naphthalene type epoxy resin having a naphthalene structure. The naphthalene type epoxy resin is a solid at normal temperature. As the compound includes a naphthalene type epoxy resin, the compact is likely to have high mechanical strength at room temperature, the heat resistance of the compact is likely to be improved, and a decrease in the mechanical strength of the compact at a high temperature is likely to be suppressed. The naphthalene type epoxy resin may be, for example, at least one resin selected from the group consisting of a naphthalene epoxy compound, a naphthalene ether type epoxy resin, a naphthalene novolac type epoxy resin, a methylene-bonded dimer of a naphthalene epoxy compound, and a methylene-bonded body of a naphthalene monoepoxy compound a naphthalene diepoxy compound, and the like.

It is preferable that the naphthalene type epoxy resin is at least one of a trifunctional epoxy resin and a tetrafunctional epoxy resin. It is more preferable that the naphthalene type epoxy resin is a tetrafunctional epoxy resin. When the naphthalene type epoxy resin included in the compound is at least one of a trifunctional epoxy resin and a tetrafunctional epoxy resin, the naphthalene type epoxy resin molecules are three-dimensionally crosslinked with one another in the curing process of the compound, a rigid crosslinked network is formed in the compact, and the movement of the naphthalene type epoxy resin in the compact at a high temperature is easily suppressed. That is, the glass transition temperature of each of a trifunctional epoxy resin and a tetrafunctional epoxy resin is higher than the glass transition temperature of a bifunctional epoxy resin. Therefore, when the naphthalene epoxy resin included in the compound is at least one of a trifunctional epoxy resin and a tetrafunctional epoxy resin, the heat resistance of the compact is likely to be improved, and a decrease in the mechanical strength of the compact at a high temperature is easily suppressed.

As a commercially available product of a trifunctional naphthalene type epoxy resin or a tetrafunctional naphthalene type epoxy resin, for example, HP-4700, HP-4710, HP-4770, EXA-5740, or EXA-7311-G4, or the like manufactured by DIC Corporation may be used. At least a portion of the naphthalene type epoxy resin included in the compound may be a bifunctional epoxy resin. As a commercially available product of the bifunctional naphthalene type epoxy resin, HP-4032, HP-4032D, or the like may be used. The naphthalene type epoxy resin included in the compound may be a β-naphthol type epoxy resin.

The compound may include one kind of epoxy resin among the above-described ones. The compound may include a plurality of kinds of epoxy resins among the above-described ones.

The resin composition may include a curing agent together with the epoxy resin. Curing agents are classified into curing agents that cure epoxy resins in the range of from a low temperature to room temperature, and heat-curable type curing agents that cure epoxy resins along with heating. Examples of the curing agents that cure epoxy resins in the range of from a low temperature to room temperature include an aliphatic polyamine, polyaminoamide, and polymercaptan. Examples of the heat-curable type curing agents include an aromatic polyamine, an acid anhydride, a phenol resin (for example, a phenol novolac resin), and dicyandiamide (DICY).

When a curing agent that cures an epoxy resin in the range of from a low temperature to room temperature is used, the glass transition point of a cured product of the epoxy resin tends to be low, and the cured product of the epoxy resin tends to be soft. As a result, a compact formed from the compound is also likely to be soft. Therefore, from the viewpoint of improving the heat resistance (mechanical strength at high temperatures) of the compact, the curing agent may be preferably a heat-curable type curing agent, more preferably a phenol resin, and even more preferably a phenol novolac resin. Particularly by using a phenol novolac resin as the curing agent, a cured product of an epoxy resin having a high glass transition point is likely to be obtained. As a result, the heat resistance and mechanical strength of the compact are likely to be improved.

A portion or all of the curing agent may be a phenol resin. That is, the resin composition may include an epoxy resin and a phenol resin. For example, the phenol resin may be at least one resin selected from the group consisting of an aralkyl type phenol resin, a dicyclopentadiene type phenol resin, a salicylaldehyde type phenol resin, a novolac type phenol resin, a copolymerized type phenol resin of a benzaldehyde type phenol and an aralkyl type phenol, a para-xylylene- and/or meta-xylylene-modified phenol resin, a melamine-modified phenol resin, a terpene-modified phenol resin, a dicyclopentadiene type naphthol resin, a cyclopentadiene-modified phenol resin, a polycyclic aromatic ring-modified phenol resin, a biphenyl type phenol resin, and a triphenylmethane type phenol resin. The phenol resin may be a copolymer composed of two or more kinds among the above-described ones. As a commercially available product of the phenol resin, for example, TAMANOL 758 manufactured by ARAKAWA CHEMICAL INDUSTRIES, LTD. or HP-850N manufactured by Showa Denko Materials Co., Ltd. may be used.

The phenol novolac resin may be, for example, a resin obtainable by condensing or co-condensing phenols and/or naphthols with aldehydes in the presence of an acidic catalyst. The phenols constituting the phenol novolac resin may be, for example, at least one selected from the group consisting of phenol, cresol, xylenol, resorcin, catechol, bisphenol A, bisphenol F, phenylphenol, and aminophenol. The naphthols constituting the phenol novolac resin may be, for example, at least one selected from the group consisting of a-naphthol, β-naphthol, and dihydroxynaphthalene. The aldehydes constituting the phenol novolac resin may be, for example, at least one selected from the group consisting of formaldehyde, acetaldehyde, propionaldehyde, benzaldehyde, and salicylaldehyde.

The curing agent may be, for example, a compound having two phenolic hydroxyl groups in one molecule. The compound having two phenolic hydroxyl groups in one molecule may be, for example, at least one selected from the group consisting of resorcin, catechol, bisphenol A, bisphenol F, and substituted or unsubstituted biphenol.

The compound may include one kind of phenol resin among the above-described ones as the curing agent. The compound may also include a plurality of kinds of phenol resins among the above-described ones as the curing agents.

The ratio of the hydroxyl group equivalent of the phenol resin with respect to the epoxy equivalent of the epoxy resin may be 0.5 or more and 1.5 or less, 0.9 or more and 1.4 or less, 1.0 or more and 1.4 or less, or 1.0 or more and 1.2 or less. That is, the ratio of an active group (phenolic OH group) in the phenol resin reacting with an epoxy group in the epoxy resin may be preferably 0.5 equivalents or more and 1.5 equivalents or less, more preferably 0.9 equivalents or more and 1.4 equivalents or less, even more preferably 1.0 equivalents or more and 1.4 equivalents or less, and particularly preferably 1.0 equivalents or more and 1.2 equivalents or less, with respect to 1 equivalent of epoxy groups in the epoxy resin. When the ratio of the active group in the phenol resin is less than 0.5 equivalents, the OH amount per unit weight of the epoxy resin after curing becomes small, and the curing rate of the resin composition (epoxy resin) is decreased. Furthermore, when the ratio of the active group in the phenol resin is less than 0.5 equivalents, the glass transition temperature of the obtained cured product is likely to decrease, a sufficient elastic modulus of the cured product is less likely to be obtained, and the oil resistance of the compact (for example, a bonded magnet) is likely to decrease. On the other hand, when the ratio of the active group in the phenol resin is more than 1.5 equivalents, the mechanical strength of a compact formed from the compound tends to decrease. However, even when the ratio of the active group in the phenol resin is outside the above-described range, the effects according to the present invention are obtained.

The resin composition may include a curing accelerator together with the epoxy resin (and phenol resin). For example, the curing accelerator is not limited as long as it is a composition capable of reacting with an epoxy resin and accelerating curing of the epoxy resin. The curing accelerator is preferably a phosphorus-based curing accelerator. For example, the phosphorus-based curing accelerator may be at least one curing accelerator selected from the group consisting of triphenylphosphine-benzoquinone, tris-4-hydroxyphenylphosphine-benzoquinone, tetraphenylphosphonium tetrakis(4-methylphenyl)borate, and tetra(n-butyl)phosphonium tetraphenylborate, and the like. As the compound contains a curing accelerator, the moldability and mold releasability of the compound are likely to be improved. A compact produced from a compound including the above-described curing accelerator is likely to have excellent mechanical strength. Furthermore, a compound including the above-described curing accelerator is likely to be stored stably over a long time period even in a high-temperature and high-humidity environment. The curing accelerator may be, for example, imidazoles such as an alkyl group-substituted imidazole or benzimidazole. The compound may include one kind of curing accelerator. The compound may include a plurality of kinds of curing accelerators.

The blending amount of the curing accelerator may be any amount capable of obtaining a curing accelerating effect and is not particularly limited. However, from the viewpoint of improving the curability and fluidity of the resin composition absorbing moisture, the blending amount of the curing accelerator may be preferably 0.1 parts by mass or more and 30 parts by mass or less, and more preferably 1 part by mass or more and 15 parts by mass or less, with respect to 100 parts by mass of the epoxy resin. The content of the curing accelerator is preferably 0.001 parts by mass or more and 5 parts by mass or less with respect to the total mass of the epoxy resin and the curing agent (for example, phenol resin). When the blending amount of the curing accelerator is less than 0.1 parts by mass, it is difficult to obtain a sufficient curing accelerator effect. When the blending amount of the curing accelerator is more than 30 parts by mass, the storage stability of the compound is likely to be decreased. However, even when the blending amount and content of the curing accelerator are outside the above-described ranges, the effects according to the present invention are obtained.

A viscosity (melt viscosity) at 100° C. of the resin composition may be 1 Pa·s or more and 50 Pas or less. A viscosity (melt viscosity) at 50° ° C. of the resin composition after being heated at 100° C. for 30 minutes is represented by Vf, a viscosity (melt viscosity) at 50° ° C. of the resin composition before being heated at 100° C. for 30 minutes is represented by Vi, and Vf may be higher than Vi. The resin composition may be a solid at 25° C. When the viscosity at 100° C. of the resin composition is 1 Pas or more and 50 Pas or less, the resin composition is likely to flow moderately in the compression molding step in the temperature range near 100° C. (for example, 90° C. to 110° C.). As a result, along with pressing of the compound, excess resin composition is easily removed from the spaces between adjacent magnetic particles, voids within a compact are likely to be filled with the resin composition, the filling ratio of the magnetic powder in the compact is likely to increase, and the density of the compact is likely to increase. From the above-described reasons, when the viscosity at 100° C. of the resin composition is 1 Pa·s or more and 50 Pas or less, the mechanical strength and magnetic characteristics (residual magnetic flux density or magnetic permeability) of the compact are likely to increase. When Vf is higher than Vi, the movement of the magnetic particles in the compact is likely to be suppressed, the direction of orientation of each magnetic particle in a compact formed in a magnetic field is likely to be maintained, and the residual magnetic flux density of a bonded magnet is likely to increase. Furthermore, when Vf is higher than Vi, the shape of the compact is likely to be maintained, and deformation of the compact is suppressed. When the resin composition is a solid at 25° C., aggregation of a compound powder at normal temperature is likely to be suppressed, and handling of the compound powder at normal temperature becomes easier.

The term “viscosity characteristics” described below means that the viscosity at 100° C. of the resin composition is 1 Pa·s or more and 50 Pa·s or less, Vf is higher than Vi, and the resin composition is a solid at 25° C.

From the viewpoint that the resin composition is likely to have the above-mentioned desired viscosity characteristics and the density of the compact is likely to increase, a solid epoxy resin having an ICI viscosity of 0.5 Pas or less may be included in the resin composition. As such an epoxy resin, NC-3000L, NC-3000, NC-3000H, NC-7300L, EPPN-502H, RE-3035-L (all manufactured by Nippon Kayaku Co., Ltd.); jER-YX-4000, jER-YX-4000H, jER-YL-6121 (all manufactured by Mitsubishi Chemical Corporation); EPICLON HP-7200L, EPICLON HP4770 (all manufactured by DIC Corporation); and the like may be used.

The resin composition may include a solid epoxy resin to which a semisolid epoxy resin is added, and a solid curing agent. As the semisolid epoxy resin, RE-303S-L, RE-303S (all manufactured by Nippon Kayaku Co., Ltd.); EPIKOTE 825, EPIKOTE 827, EPIKOTE 828, EPIKOTE 828EL, EPIKOTE 828US, EPIKOTE 828XA, EPIKOTE 1001 (all manufactured by Mitsubishi Chemical Corporation); EPICLON 860, EPICLON 1050, EPICLON 1055, EPICLON HP-4032, EPICLON HP-4032D (all manufactured by DIC Corporation), and the like may be used.

The resin composition may include a compound having a functional group capable of reacting with an epoxy group, together with the epoxy resin (and phenol resin). The functional group capable of reacting with an epoxy group may be at least one selected from the group consisting of an amino group, a phenolic hydroxyl group, a carboxyl group, and a thiol group. The compound having the functional group capable of reacting with an epoxy group may be referred to as a coupling agent. From the viewpoint that a thermosetting reaction of the resin composition near 100° C. is likely to proceed moderately and the viscosity of the resin composition is easily increased to a predetermined viscosity in a short period of time by heating, the functional group capable of reacting with an epoxy group may be an amino group. That is, the resin composition may include a compound having an amino group as the compound having the functional group capable of reacting with an epoxy group. When the resin composition includes a compound having an amino group, during a process of forming a compact from a compound in a magnetic field in a temperature range near 100° C., a curing reaction of the resin composition proceeds to a certain extent, together with orientation of the magnetic particles along the magnetic field. As a result, the direction of orientation of the magnetic particles in the compact is likely to be fixed, and the residual magnetic flux density of a bonded magnet is likely to increase.

The compound having an amino group may be a compound having a primary amino group or a secondary amino group. From the viewpoint that the compound is likely to be dispersed stably in the compound and the mechanical strength of the compact is likely to increase, the compound having an amino group may be a silicon compound having an amino group (so-called silane coupling agent). As the silicon compound having an amino group, compounds manufactured by Shin-Etsu Chemical Co., Ltd., such as KBM-602 (N-2-(aminoethyl)-3-aminopropylmethyldimethoxysilane), KBM-603 (N-2-(aminoethyl)-3-aminopropyltrimethoxysilane), KBM-903 (3-aminopropyltrimethoxysilane), KBE-903 (3-aminopropyltriethoxysilane), KBE-9103P (3-triethoxysilyl-N-(1,3-dimethylbutylidene)propylamine), KBM-573 (N-phenyl-3-aminopropyltrimethoxysilane), and KBM-6803 (N-2-(aminoethyl)-3-aminopropyltrimethoxysilane) may be used. The resin composition may include one kind of silicon compound having an amino group. The resin composition may include a plurality of kinds of silicon compounds having an amino group.

The mass of the compound having a functional group capable of reacting with an epoxy group may be 1 part by mass or more and 20 parts by mass or less, with respect to 100 parts by mass of the resin composition. The mass of the compound having a functional group capable of reacting an epoxy group may be 1 part by mass or more and 30 parts by mass or less with respect to 100 parts by mass of the epoxy resin. When the mass of the compound having a functional group capable of reacting with an epoxy group is in the above-described range, the above-described effect attributable to the compound having a functional group capable of reacting with an epoxy group is likely to be obtained.

The resin composition may include a reactive diluent. The resin composition may include an epoxy resin and a reactive diluent. When the epoxy resin is diluted with the reactive diluent, the resin composition is likely to have the above-mentioned desired viscosity characteristics. The reactive diluent may be, for example, at least either one of a monoepoxy compound and a diepoxy compound. The reactive diluent may be a monofunctional epoxy resin. The reactive diluent may be, for example, at least one selected from the group consisting of an alkyl monoglycidyl ether, an alkylphenol monoglycidyl ether, and an alkyl diglycidyl ether. As a commercially available product of the alkyl monoglycidyl ether, for example, YED188 or YED111N manufactured by Mitsubishi Chemical Corporation may be used. As a commercially available product of the alkylphenol monoglycidyl ether, for example, EPICLON 520 manufactured by DIC Corporation or YED122 manufactured by Mitsubishi Chemical Corporation may be used. As a commercially available product of the alkyl diglycidyl ether, for example, YED216M or YED216D manufactured by Mitsubishi Chemical Corporation may be used.

The resin composition may include a bismaleimide. A bismaleimide is a compound (for example, monomer or polymer) including a structural unit having at least two maleimide groups. The resin composition may include an aminophenol adduct of bismaleimide. An aminophenol adduct (for example, addition polymer) of bismaleimide is a product of an addition reaction between bismaleimides and aminophenols. That is, an aminophenol adduct of bismaleimide is obtained by an addition reaction (for example, addition polymerization reaction) of bismaleimides and aminophenols. An imide ring and a phenyl ring constituting the aminophenol adduct of bismaleimide are rigid. The crosslink density of an aminophenol adduct of bismaleimide is relatively high. Due to these various characteristics, an aminophenol adduct of bismaleimide has excellent heat resistance and does not easily undergo thermal expansion as compared with conventional thermosetting resins (for example, an epoxy resin). In other words, an aminophenol adduct of bismaleimide is less likely to be softened and deformed at high temperatures. Therefore, products (for example, a bonded magnet or a dust core) produced by compression molding and heating of a compound including an aminophenol adduct of bismaleimide can have high mechanical strength at high temperatures (for example, 150° C.).

The resin composition may include a bismaleimide resin. The bismaleimide resin is preferably a powder. The bismaleimide resin may be a product (addition polymer) of an addition reaction of polymaleimides (a) and an aminophenols (b). That is, the bismaleimide resin may be an aminophenol adduct.

The bismaleimide resin may include a product of an addition reaction of polymaleimides (a) and aminophenols (b) as well as an epoxy compound (c). That is, an epoxy compound (c) (epoxy resin) may be added to the aminophenol adduct of bismaleimide. A product of an addition reaction is obtained by a reaction between a polymaleimides (a) and an aminophenols (b), and by adding an epoxy compound (c) to the product of the addition reaction, a bismaleimide resin may be obtained. By thermally curing the aminophenol adduct of bismaleimide to which an epoxy compound (c) is added, the aminophenol adduct of bismaleimide is modified with the epoxy compound (c), and a complicated network structure composed of the aminophenol adduct of bismaleimide and the epoxy compound (c) is formed. As a result, the glass transition temperature of a cured product formed from the aminophenol adduct of bismaleimide and the epoxy compound (c) is likely to increase, and the mechanical strength at high temperatures of a product produced from the compound is likely to increase.

The polymaleimides (a) constituting the bismaleimide resin are represented by the following Chemical Formula A. The polymaleimides (a) may be referred to as bismaleimides (a). The resin composition may include at least one of a monomer consisting of bismaleimides (a) and a polymer composed of bismaleimides (a). The resin composition may include an aminophenol adduct, which is at least one of a monomer consisting of bismaleimides (a) and a polymer composed of bismaleimides (a).

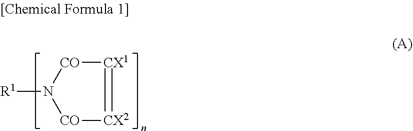

R¹ in Chemical Formula A is an n-valent organic group. Each of X¹ and X² are a monovalent atom selected from hydrogen or a halogen, or a monovalent organic group. X¹ and X² may be identical, or X¹ and X² may be different from each other. n in Chemical Formula A is an integer of 2 or greater.

The polymaleimides (a) may be, for example, at least one compound selected from the group consisting of ethylene bismaleimide, hexamethylene bismaleimide, m-phenylene bismaleimide, p-phenylene bismaleimide, 4,4′-diphenylmethane bismaleimide, 4,4′-diphenyl ether bismaleimide, 4,4′-diphenylsulfone bismaleimide, 4,4′-dicyclohexylmethane bismaleimide, m-xylylene bismaleimide, p-xylylene bismaleimide, and 4,4′-phenylene bismaleimide. If necessary, the above-described polymaleimides (a) and monomaleimides may be included in the bismaleimide resin. The monomaleimides may be, for example, N-3-chlorophenylmaleimide or N-4-nitrophenylmaleimide.

The above-described aminophenols (b) constituting the bismaleimide resin is represented by the following Chemical Formula (B).

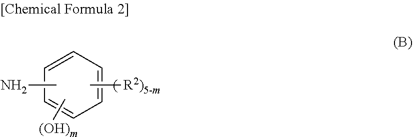

R² in Chemical Formula B is a monovalent atom selected from hydrogen or a halogen, or a monovalent organic group. m in Chemical Formula B is an integer of 1 to 5.

The aminophenols (b) may be at least one compound selected from the group consisting of o-aminophenol, m-aminophenol, p-aminophenol, o-aminocresol, m-aminocresol, p-aminocresol, aminoxylenol, aminochlorophenol, aminobromophenol, aminocatechol, aminoresorcin, aminobis(hydroxyphenol)propane, and aminooxybenzoic acid.

The above-described epoxy compound (c) constituting the bismaleimide resin has two or more epoxy groups in the molecule. The epoxy compound (c) may be, for example, at least one compound selected from the group consisting of a bisphenol A type epoxy resin, a bisphenol F type epoxy resin, a novolac type epoxy resin, a glycidyl ester resin of a polycarboxylic acid, a polyglycidyl ether of a polyol, a urethane-modified epoxy resin, a fatty acid type polyepoxide obtained by epoxidizing an unsaturated compound, an alicyclic type polyepoxide obtained by epoxidizing an unsaturated compound, an epoxy resin having a heterocyclic ring, an epoxy resin having a heterocyclic ring, and an epoxy resin obtained by glycidylating an amine.

An addition reaction product is obtained by a reaction between the above-mentioned polymaleimides (a) and an aminophenols (b). The proportion by mass of the aminophenols (b) may be 5 to 40 parts by mass, and preferably 10 to 30 parts by mass, with respect to 100 parts by mass of the polymaleimides (a). When the proportion by mass of the aminophenols (b) is less than 5 parts by mass, the compatibility between the addition reaction product and the epoxy compound (c) is insufficient. When the proportion by mass of the aminophenols (b) is more than 40 parts by mass, the bismaleimide resin includes excess amino groups, and the heat resistance of the bismaleimide resin is decreased. The reaction temperature for the polymaleimides (a) and the aminophenols (b) may be, for example, 50° C. to 200° C., and preferably 80° ° C. to 180ºC. The reaction time for the polymaleimides (a) and the aminophenols (b) may be appropriately adjusted in the range of several minutes to several dozen hours.

The content of the above-described addition reaction product in the bismaleimide resin may be 30% to 80% by mass. When the content of the addition reaction product is less than 30% by mass, the heat resistance of the bismaleimide resin is decreased. When the content of the addition reaction product is more than 80% by mass, the mechanical strength of the bismaleimide resin is decreased. However, even when the content of the above-described addition reaction product in the bismaleimide resin is outside the above-described range, the effects of the present invention can be obtained.

The bismaleimide resin (aminophenol adduct of bismaleimide) may be, for example, at least one resin selected from KIR-3, KIR-30, KIR-50, and KIR-100 (all trade names manufactured by KYOCERA Corporation). KIR-3 is an example of an aminophenol adduct of bismaleimide that does not include an epoxy compound (c) (epoxy resin). KIR-30 is an example of an aminophenol adduct of bismaleimide to which an epoxy compound (c) (epoxy resin) is added.

The resin composition may include a polyimide resin. For example, the polyimide resin may be a dehydration polycondensation product of a tetracarboxylic acid anhydride and 4,4′-bis(3-aminophenoxy)biphenyl. The polyimide resin may be at least one resin selected from AURUM PL450C, AURUM PL500A, AURUM PL6200, AURUM PD450L (all trade names manufactured by Mitsui Chemicals, Inc.), Solver PI-5600 (trade name manufactured by Solver Polyimide Company), and THERPLIM (trade name manufactured by MITSUBISHI GAS CHEMICAL COMPANY, INC.).

The resin composition may include a polyamide resin. For example, the polyamide resin may be at least either one of nylon 6 particles obtainable from 8-caprolactam and nylon 12 particles obtainable from lauryl lactam. For example, the polyamide resin may be at least one resin selected from the group consisting of particles formed from nylon 6 (TR-1 and TR-2 manufactured by Toray Industries, Inc.) and particles formed from nylon 12 (SP-500 and SP-10 manufactured by Toray Industries, Inc.).

The resin composition may include a polyamideimide resin. For example, the polyamideimide resin may be a polyamideimide resin having a siloxane structure. The polyamideimide resin may have two or more carboxy groups at at least one end of the two ends of a molecular chain of the polyamideimide. The polyamideimide resin may be a polyamideimide resin described in Japanese Unexamined Patent Publication No. 2019-48948.

The resin composition may include the above-mentioned plurality of kinds of resins. The resin composition may further include another resin in addition to the above-described resins. For example, the resin composition may further include at least one other resin selected from the group consisting of a polyphenylene sulfide resin, an acrylic resin, polyethylene, polypropylene, polystyrene, polyvinyl chloride, polyethylene terephthalate, and a silicone resin.

The resin composition may further include other additives in addition to the above-mentioned components. For example, the additives may be at least one compound selected from the group consisting of a flow aid, a flame retardant, a lubricating agent, and an organic solvent.

The total mass of a plurality of magnetic particles is represented by Mm, the total mass of the first silicon compound, the second silicon compound, and the resin composition is represented by Mr, and Mm/Mr may be 94/6 or more and 99/1 or less. When Mm/Mr is in the above-described range, the compound is likely to have moderate fluidity, compression molding of the compound is easy, and the density and the mechanical strength of a compact formed from the compound are likely to be compatible.

(Method for Producing Compound)

A method for producing a compound is not particularly limited; however, for example, the method may be as follows. First, a resin solution is prepared by uniformly stirring and mixing a magnetic powder including a first silicon compound and a second silicon compound, each of the above-mentioned components constituting the resin composition, and an organic solvent. The organic solvent may be a liquid capable of dissolving each of the components of the resin composition and is not particularly limited. The organic solvent may be, for example, at least one selected from the group consisting of acetone, N-methylpyrrolidinone (N-methyl-2-pyrrolidone), y-butyrolactone, dimethylformamide, dimethyl sulfoxide, methyl ethyl ketone, methyl isobutyl ketone, benzene, toluene, and xylene. When workability is considered, the organic solvent is preferably a liquid at normal temperature, and the boiling point of the organic solvent is preferably 60° ° C. or higher and 150° C. or lower. As such a solvent, for example, acetone or methyl ethyl ketone is preferred.

By sufficiently removing the organic solvent from the above-described resin solution, a compound (powder) is obtained. Along with the removal of the organic solvent, the resin composition easily attaches uniformly to the surface of each magnetic particle. The resin composition may attach to the entire surface of each magnetic particle or may attach only to a portion of the surface of each magnetic particle. The method for removing the organic solvent from the resin solution is not particularly limited. For example, the organic solvent can be removed from the resin solution by drying the resin solution. The method for drying the resin solution may be, for example, vacuum drying. In order to reduce damage of the mold in the compression molding step that will be described below, a lubricating agent may be added to the compound. The lubricating agent is not particularly limited. The lubricating agent may be, for example, at least one selected from the group consisting of a metal soap and a wax-based lubricating agent. A compound powder is obtained by the above-described method. In order to reduce damage of the mold, a liquid dispersion may be prepared by dispersing a lubricating agent in an appropriate dispersion medium, and the liquid dispersion may be applied on the wall surface inside the mold dice (wall surface in contact with the punch), and the applied liquid dispersion may be dried.

(Method for Producing Compact)

A compact is obtained by compression molding of the above-described compound filled inside a mold. As the molding pressure is higher, the magnetic characteristics (residual magnetic flux density or magnetic permeability) and mechanical strength of the compact are increased. The molding pressure may be, for example, 500 MPa or higher and 2500 MPa or lower. When mass productivity and the mold life are also considered, the molding pressure may be 700 MPa or higher and 2000 MPa or lower. The density of the compact may be preferably 75% or higher and 90% or lower, and more preferably 80% or higher and 90% or lower, with respect to the true density of the magnetic particles. When the density of the compact is in the above-described range with respect to the true density of the magnetic particles, a compact having excellent magnetic characteristics and mechanical strength can be produced. Along with the compression molding of the compound, the compound may be heated. When a compact for a bonded magnet is produced from the compound, a compact may be obtained by compression molding of the compound in a magnetic field.

A heat treatment of the compact is performed. As a result of the heat treatment of the compact, the resin composition in the compact is cured, and the magnetic particles in the compact are bound to each other by a cured product of the resin composition. As a result of the heat treatment of the compact, the glycidyl group included in the second silicon compound reacts with a functional group remaining in the cured product of the resin composition, and the second silicon compound is chemically bonded to the cured product of the resin composition. Due to the bonding between the second silicon compound and the cured product of the resin composition, the magnetic particles are strongly bound to each other through the resin composition. As a result of curing of the resin composition as described above and bonding between the second silicon compound and the cured product of the resin composition, the mechanical strength of the compact (bonded magnet and dust core) is increased. The heat treatment temperature of the compact may be any temperature at which the resin composition is sufficiently cured. The heat treatment temperature of the compact may be, for example, 150° C. or higher and 450° C. or lower, and preferably 200° C. or higher and 350° ° C. or lower. The atmosphere of the heat treatment may be air atmosphere (preferably, dry air) or an inert atmosphere (for example, nitrogen). In order to suppress oxidation of the magnetic particles in the compact, it is preferable to perform the heat treatment of the compact in an inert atmosphere. When the heat treatment temperature is too high, due to a trace amount of oxygen unavoidably included in the compact during the production process, the magnetic particles are likely to be oxidized, and the resin composition is likely to be deteriorated. Furthermore, in order to suppress oxidation of the magnetic particles and deterioration of the resin composition, the time for retaining the above-described heat treatment temperature may be several minutes or more and 4 hours or less, and preferably 15 minutes or more and 3 hours or less.

### EXAMPLES

The present invention will be described in detail by way of the following Examples and Comparative Examples. The present invention is not intended to be limited by the following Examples.

<Silane Coupling Agent>

General compound names of the silane coupling agents described in the following Tables 1 to 3 are as follows. All the following silane coupling agents are manufactured products of Shin-Etsu Chemical Co., Ltd.
KBM-13: Methyltriethoxysilane
KBM-3063: n-hexyltrimethoxysilane
KBM-3103C: n-decyltrimethoxysilane
KBM-403: 3-Glycidoxypropyltrimethoxysilane
KBM-4803: 8-Glycidoxyoctyltrimethoxysilane
KBM-103: Phenyltrimethoxysilane
KBM-903: 3-Aminopropyltrimethoxysilane
n in the following Tables 1 to 3 is the number of carbon atoms of the alkyl group included in each first silicon compound.
m in the following Tables 1 to 3 is the number of carbon atoms of the alkyl chain included in each second silicon compound.

A numerical value whose unit is m²/g in the following Tables 1 to 3 is the minimum covering area of each silane coupling agent.

### Example 1

<Production of Magnetic Powder>

As a raw material powder (magnetic particles) for a magnetic powder, a powder consisting of a Sm—Fe—N-based magnet (magnet powder manufactured by NICHIA CORPORATION) was used. The specific surface area of the raw material powder measured by a BET method was 2.549 m²/g. The raw material powder was spherically shaped. The average particle size of the raw material powder was 2.9 μm.

The raw material powder, a first coupling agent, and a second coupling agent were stirred in a bottle made of polyethylene to obtain a mixture of the raw material powder, the first coupling agent, and the second coupling agent. The volume of the bottle made of polyethylene was 250 ml. For the stirring, a rotary mixer was used. The mixture was left for 48 hours, and then the mixture was dried at 100° C. for 2 hours by using a constant temperature dryer. A magnetic powder of Example 1 was produced by the above-described method.

The type of each of the first coupling agent and the second coupling agent used for the production of the magnetic powder of Example 1 is shown in the following Table 1. The mass of each of the raw material powder, the first coupling agent, and the second coupling agent is shown in the following Table 1.

<Production of Compound>

A solution (resin solution) of a resin composition was prepared by mixing a thermosetting resin, a curing agent, a coupling agent (compound having a functional group capable of reacting with an epoxy group), a curing accelerator (curing catalyst), and acetone in an eggplant-shaped flask.

As the thermosetting resin, a biphenyl type epoxy resin (YX-4000H manufactured by Mitsubishi Chemical Corporation) having an epoxy equivalent of 192 g/eq was used.

As the curing agent, a phenol novolac resin (HP-850N manufactured by Showa Denko Materials Co., Ltd.) having a hydroxyl group equivalent of 108 was used.

As the coupling agent (compound having a functional group capable of reacting an epoxy group), with N-phenyl-3-aminopropyltrimethoxysilane (KBM-573 manufactured by Shin-Etsu Chemical Co., Ltd.) was used.

As the curing accelerator, tetra(n-butyl)phosphonium tetraphenylborate (PX-4PB manufactured by Nippon Chemical Industrial Co., Ltd.) was used.

The volume of acetone was 50 ml.

The capacity of the eggplant-shaped flask was 300 ml.

The mass of each of YX-4000H, HP-850N, KBM-573, and PX-4PB is shown in the following Table 1.

All of the above-described magnetic powder was added to the resin solution in the flask, and then the mixture of the magnetic powder and the resin solution was stirred for 10 minutes. After stirring of the mixture, acetone was distilled off from the mixture at 25° C. by using an evaporator. At the time point when almost no liquid was seen in the flask, solids (lumps) in the flask were loosened, and the pressure inside the flask was reduced for 30 minutes with an evaporator. After pressure reduction in the flask, solids collected from the flask were spread on a vat. The solids on the vat were dried in a vacuum at normal temperature for one day. A vacuum dryer was used for the drying. After drying of the solids, a compound powder of Example 1 was obtained by pulverizing the solids placed in a plastic bag with a hammer.

<Production of Compact>

A rectangular parallelepiped-shaped compact was obtained by compressing the compound at 1000 MPa while heating the compound powder filled in a mold at 100° C. The dimensions of the cavity of the mold were 7 mm in width×7 mm in depth. For the compression of the compound, a hydraulic press machine was used. The compact was installed in a dryer, heated from normal temperature to 200° ° C. at a temperature increase rate of 5° C./min, and maintained at 200° ° C. for 10 minutes. The compact taken out from the dryer was cooled to normal temperature.

<Measurement of Density of Compact>

The dimensions (length, width, and height) of the compact were measured with a micrometer. The volume of the compact was calculated from the measured dimensions of the compact. The mass of the compact was measured with an electronic balance. The density of the compact of Example 1 was calculated by dividing the mass of the compact by the volume of the compact. The density of the compact of Example 1 is shown in the following Table 1.

<Measurement of Crushing Strength of Compact>

A compression pressure was applied to an end face of the above-described compact by using a universal compression tester. That is, a compression pressure was applied to the compact in the height direction of the compact. The compression pressure was increased, and the compression pressure when the compact was destroyed was measured. The compression pressure when the compact was destroyed means crushing strength. AG-10TBR manufactured by SHIMADZU CORPORATION was used as the universal compression tester. The speed of the crosshead in the measurement of the crushing strength was 0.5 mm/min. The measurement of the crushing strength was performed in an atmosphere at room temperature (25° C.). The crushing strength of the compact of Example 1 is shown in the following Table 1.

### Examples 2 to 6 and Comparative Examples 1 to 6

For the production of a magnetic powder of each of Examples 2 to 6 and Comparative Examples 2 to 6, silane coupling agents shown in the following Table 1 were used. The mass of each silane coupling agent used for the production of the magnetic powder of each of Examples 2 to 6 and Comparative Examples 2 to 6 is shown in the following Table 1.

The magnetic powder of each of Examples 2 to 6 and Comparative Examples 2 to 6 was produced by a method similar to that of Example 1, except for the above-described matters.

In Comparative Example 1, the raw material powder itself was used as the magnetic powder. That is, the magnetic powder of Comparative Example 1 did not include a silane coupling agent.

A compound powder and a compact of each of Examples 2 to 6 and Comparative Examples 1 to 6 were produced by methods similar to that of Example 1, except for the above-described matters. The density and crushing strength of the compact of each of Examples 2 to 6 and Comparative Examples 1 to 6 were measured by methods similar to those of Example 1. The density and crushing strength of the compact of each of Examples 2 to 6 and Comparative Examples 1 to 6 are shown in the following Table 1.

The target value for the density of the compact including a Sm—Fe—N-based magnet is 5.45 g/cm³, and the target value for the crushing strength of the compact including a Sm—Fe—N-based magnet is 155 MPa. It is preferable that both of the density and the crushing strength of the compact are equal to or greater than the target values.

TABLE 1

| | | | Example | Example | Example | Example | Example | Example | Comparative |
|---|---|---|---|---|---|---|---|---|---|
| | | Unit | 1 | 2 | 3 | 4 | 5 | 6 | Example 1 |
| Raw material | Sm—Fe—N | g | 200 | 200 | 200 | 200 | 200 | 200 | 200 |
| powder | | | | | | | | | |
| First | KBM-13 | g | 0.712 | 0.534 | 0.356 | 0 | 0 | 0 | 0 |
| coupling | n = 1 | | | | | | | | |
| agent | (573 m²/g) | | | | | | | | |
| including | KBM-3063 | g | 0 | 0 | 0 | 0.859 | 0.644 | 0.429 | 0 |
| alkyl | n = 6 | | | | | | | | |
| group | (475 m²/g) | | | | | | | | |
| | KBM-3103C | g | 0 | 0 | 0 | 0 | 0 | 0 | 0 |
| | n = 10 | | | | | | | | |
| | (297 m²/g) | | | | | | | | |
| Second | KBM-403 | g | 0.309 | 0.618 | 0.927 | 0 | 0 | 0 | 0 |
| coupling | m = 3 | | | | | | | | |
| agent | (330 m²/g) | | | | | | | | |
| including | KBM-4803 | g | 0 | 0 | 0 | 0.401 | 0.803 | 1.204 | 0 |
| glycidyl | m = 8 | | | | | | | | |
| group | (254 m²/g) | | | | | | | | |
| Coupling | KBM-103 | g | 0 | 0 | 0 | 0 | 0 | 0 | 0 |
| agent | (393 m²/g) | | | | | | | | |
| including | | | | | | | | | |
| phenyl group | | | | | | | | | |
| Coupling | KBM-903 | g | 0 | 0 | 0 | 0 | 0 | 0 | 0 |
| agent | (435 m²/g) | | | | | | | | |
| including | | | | | | | | | |
| amino group | | | | | | | | | |
| Resin | YX-4000H | g | 4.428 | 4.428 | 4.428 | 4.428 | 4.428 | 4.428 | 4.428 |
| composition | HP-850N | g | 2.491 | 2.491 | 2.491 | 2.491 | 2.491 | 2.491 | 2.491 |
| | PX-4PB | g | 0.214 | 0.214 | 0.214 | 0.214 | 0.214 | 0.214 | 0.214 |
| | KBM-573 | g | 1.200 | 1.200 | 1.200 | 1.200 | 1.200 | 1.200 | 1.200 |
| Compact | Density | g/cm³ | 5.51 | 5.49 | 5.46 | 5.50 | 5.47 | 5.45 | 5.41 |
| | Crushing | MPa | 155 | 158 | 163 | 155 | 157 | 162 | 152 |
| | strength | | | | | | | | |

| | | Comparative | Comparative | Comparative | Comparative | Comparative |
|---|---|---|---|---|---|---|
| | | Example 2 | Example 3 | Example 4 | Example 5 | Example 6 |
| Raw material | Sm—Fe—N | 200 | 200 | 200 | 200 | 200 |
| powder | | | | | | |
| First | KBM-13 | 0 | 0 | 0 | 0.07 | 0 |
| coupling | n = 1 | | | | | |
| agent | (573 m²/g) | | | | | |
| including | KBM-3063 | 0 | 0 | 0 | 0 | 0 |
| alkyl | n = 6 | | | | | |
| group | (475 m²/g) | | | | | |
| | KBM-3103C | 0 | 1.716 | 1.030 | 0 | 0 |
| | n = 10 | | | | | |
| | (297 m²/g) | | | | | |
| Second | KBM-403 | 1.545 | 0 | 0.618 | 0 | 0 |
| coupling | m = 3 | | | | | |
| agent | (330 m²/g) | | | | | |
| including | KBM-4803 | 0 | 0 | 0 | 0 | 0 |
| glycidyl | m = 8 | | | | | |
| group | (254 m²/g) | | | | | |
| Coupling | KBM-103 | 0 | 0 | 0 | 0 | 0.4 |
| agent | (393 m²/g) | | | | | |
| including | | | | | | |
| phenyl group | | | | | | |
| Coupling | KBM-903 | 0 | 0 | 0 | 0.4 | 0.4 |
| agent | (435 m²/g) | | | | | |
| including | | | | | | |
| amino group | | | | | | |
| Resin | YX-4000H | 4.428 | 4.428 | 4.428 | 4.428 | 4.428 |
| composition | HP-850N | 2.491 | 2.491 | 2.491 | 2.491 | 2.491 |
| | PX-4PB | 0.214 | 0.214 | 0.214 | 0.214 | 0.214 |
| | KBM-573 | 1.200 | 1.200 | 1.200 | 1.200 | 1.200 |
| Compact | Density | 5.05 | 5.51 | 5.01 | 5.21 | 5.07 |
| | Crushing | 163 | 125 | 130 | 148 | 145 |
| | strength | | | | | |

### Example 7 and Comparative Example 7

As a raw material powder (magnetic particles) for the magnetic powder of each of Example 7 and Comparative Example 7, a powder consisting of a Nd—Fe—B-based magnet was used. The powder consisting of a Nd—Fe—B-based magnet was MQP-B manufactured by Magnequench International, LLC. The average particle size of the powder consisting of a Nd—Fe—B-based magnet was 100 μm. The mass of the raw material powder used for the production of the magnetic powder of each of Example 7 and Comparative Example 7 is shown in the following Table 2.

For the production of the magnetic powder of each of Example 7 and Comparative Example 7, the silane coupling agents shown in the following Table 2 were used. The mass of each silane coupling agent used for the production of the magnetic powder of each of Example 7 and Comparative Example 7 is shown in the following Table 2.

The magnetic powder of each of Example 7 and Comparative Example 7 was produced by a method similar to that of Example 1, except for the above-described matters.

As a raw material for the resin solution of each of Example 7 and Comparative Example 7, HP-4700, HP-850N, PX-4PB, and acetone were used. HP-4700 is a tetrafunctional naphthalene type epoxy resin manufactured by DIC Corporation. The epoxy equivalent of HP-4700 is 160 g/eq. The mass of each of HP-4700, HP-850N, and PX-4PB used for the production of the resin solution of each of Example 7 and Comparative Example 7 is shown in the following Table 2.

A compound powder of each of Example 7 and Comparative Example 7 was produced by a method similar to that of Example 1, except for the above-described matters.

A compact of each of Example 7 and Comparative Example 7 was produced by the following method.

A ring-shaped (cylindrical-shaped) compact was obtained by compression molding of a compound powder using a hydraulic press machine. The pressure for compression molding was 1200 MPa. The outer diameter of the ring-shaped compact was 30 mm, the inner diameter of the ring-shaped compact was 20 mm, and the height of the ring-shaped compact was 5 mm. The ring-shaped (cylindrical-shaped) compact was completed by a heat treatment of the compact in a dry atmosphere. The heat treatment temperature was 180ºC, and the heat treatment time was 60 minutes.

The volume of the ring-shaped compact was calculated from the dimensions of the compact measured with a micrometer. The mass of the compact was measured with an electronic balance. The density of the compact was calculated by dividing the mass of the compact by the volume of the compact. The density of the compact of each of Example 7 and Comparative Example 7 is shown in the following Table 2.

A compression pressure was applied to a side surface of the compact in a direction perpendicular to the central axis line of the ring-shaped compact. The compression pressure was increased, and the compression pressure when the compact was destroyed was measured. The compression pressure when the compact was destroyed means radial crushing strength (unit: MPa). The measurement of the radial crushing strength was performed in an atmosphere at room temperature (25° C.). The radial crushing strength of each of Example 7 and Comparative Example 7 is shown in the following Table 2.

As shown in the following Table 2, the compact of Example 7 was superior to the compact of Comparative Example 7 in terms of both the density and the radial crushing strength.

TABLE 2

| | | | | Comparative |
|---|---|---|---|---|
| | | Unit | Example 7 | Example 7 |
| Raw material powder | Nd—Fe—B | g | 100 | 100 |
| First coupling agent | KBM-13 | g | 0.012 | 0 |
| including alkyl group | n = 1 | | | |
| | (573 m²/g) | | | |
| Second coupling agent | KBM-403 | g | 0.189 | 0.210 |
| including glycidyl group | m = 3 | | | |
| | (330 m²/g) | | | |
| Resin composition | HP-4700 | g | 1.820 | 1.820 |
| | HP-850N | g | 1.191 | 1.191 |
| | PX-4PB | g | 0.088 | 0.088 |
| Compact | Density | g/cm³ | 6.21 | 6.07 |
| | Radial | MPa | 75.2 | 51.7 |
| | crushing | | | |
| | strength | | | |

### Example 8 and Comparative Examples 8 and 9

As a raw material powder (magnetic particles) for a magnetic powder of each of Example 8 and Comparative Examples 8 and 9, a pure iron powder was used. As the pure iron powder, a commercial product (Somaloy 500H) manufactured by Höganäs AB was used. The average particle size of the pure iron powder was 75 μm. The mass of the pure iron powder used for the production of the magnetic powder of each of Example 8 and Comparative Examples 8 and 9 is shown in the following Table 3.

For the production of the magnetic powder of each of Example 8 and Comparative Example 9, the silane coupling agents shown in the following Table 3 were used. The mass of each silane coupling agent used for the production of the magnetic powder of each of Example 8 and Comparative Example 9 is shown in the following Table 3.

In Comparative Example 8, the raw material powder itself was used as the magnetic powder. That is, the magnetic powder of Comparative Example 8 did not include a silane coupling agent.

The magnetic powder of each of Example 8 and Comparative Examples 8 and 9 was produced by a method similar to that of Example 1, except for the above-described matters.

A compound powder of each of Example 8 and Comparative Examples 8 and 9 was produced by the following method.

A compound powder was obtained by mixing a magnetic powder, a bismaleimide resin (thermosetting resin), and calcium caprylate (lubricating agent) for 30 minutes with a V-type mixer. A commercial product manufactured by KYOCERA Corporation (KIR-30) was used as the bismaleimide resin. The mass of KIR-30 used for the production of the compound powder of each of Example 8 and Comparative Examples 8 and 9 is shown in the following Table 3.

A compact of each of Example 8 and Comparative Examples 8 and 9 was produced by the following method.

A ring-shaped (cylindrical-shaped) compact was obtained by compression molding of a compound powder using a hydraulic press machine. The pressure for compression molding was 1200 MPa. The outer diameter of the ring-shaped compact was 30 mm, the inner diameter of the ring-shaped compact was 20 mm, and the height of the ring-shaped compact was 5 mm. The ring-shaped (cylindrical-shaped) compact was completed by a heat treatment of the compact in a dry atmosphere. The heat treatment temperature was 300° C., and the heat treatment time was 60 minutes.

The density of the compact of each of Example 8 and Comparative Examples 8 and 9 was calculated by a method similar to that of Example 7. The density of the compact of each of Example 8 and Comparative Examples 8 and 9 is shown in the following Table 3.

The radial crushing strength of the compact of each of Example 8 and Comparative Examples 8 and 9 was measured by a method similar to that of Example 7. The radial crushing strength of each of

Example 8 and Comparative Examples 8 and 9 is shown in the following Table 3.

As shown in the following Table 3, the density of the compact of each of Example 8 and Comparative Examples 8 and 9 was approximately equal. However, the radial crushing strength of the compact of Example 8 was higher than the radial crushing strength of the compact of each of Comparative Examples 8 and 9.

TABLE 3

| | | | | Compar- | Compar- |
|---|---|---|---|---|---|
| | | | | ative | ative |
| | | | Exam- | Exam- | Exam- |
| | | Unit | ple 8 | ple 8 | ple 9 |
| Raw material | Fe | g | 110 | 110 | 110 |
| powder | | | | | |
| First coupling | KBM-13 | g | 0.013 | 0 | 0 |
| agent including | n = 1 | | | | |
| alkyl group | (573 m²/g) | | | | |
| Second coupling | KBM-403 | g | 0.208 | 0 | 0.231 |
| agent including | m = 3 | | | | |
| glycidyl group | (330 m²/g) | | | | |
| Resin composition | KIR-30 | g | 0.55 | 0.55 | 0.55 |
| Compact | Density | g/cm³ | 7.33 | 7.34 | 7.31 |
| | Radial | MPa | 98 | 74 | 95 |
| | crushing | | | | |
| | strength | | | | |

### INDUSTRIAL APPLICABILITY

For example, the magnetic powder according to an aspect of the present invention may be used as a raw material of a bonded magnet or a dust core.

### REFERENCE SIGNS LIST

1: first silicon compound, 2: second silicon compound. 3: surface of magnetic particle.

1. A magnetic powder comprising:
a plurality of magnetic particles including at least either one of a permanent magnet and a soft magnetic material;
a first silicon compound covering at least a portion of surfaces of the magnetic particles; and
a second silicon compound covering at least a portion of the surfaces of the magnetic particles,
wherein the first silicon compound includes an alkyl group and silicon bonded to the alkyl group,
the second silicon compound includes an alkyl chain, silicon bonded to one end of the alkyl chain, and a glycidyl group located at another end of the alkyl chain, and
a number m of carbon atoms of the alkyl chain included in the second silicon compound is larger than a number n of carbon atoms of the alkyl group included in the first silicon compound.

2. The magnetic powder according to claim 1,
wherein the silicon included in the first silicon compound is bonded to the surfaces of the magnetic particles through oxygen, and
the silicon included in the second silicon compound is bonded to the surfaces of the magnetic particles through oxygen.

3. The magnetic powder according to claim 1,
wherein the number n of carbon atoms of the alkyl group included in the first silicon compound is 1 or more and 6 or less.

4. The magnetic powder according to claim 1,
wherein a plurality of the magnetic particles are at least one kind of permanent magnet selected from a Sm—Fe—N-based magnet and a Nd—Fe—B-based magnet.

5. The magnetic powder according to claim 1,
wherein a plurality of the magnetic particles are at least one kind of soft magnetic material selected from a pure iron and an alloy including iron.

6. A compound comprising:
the magnetic powder according to claim 1; and
a resin composition including a functional group capable of reacting with a glycidyl group.

7. The compound according to claim 6,
wherein the resin composition includes at least one resin selected from the group consisting of an epoxy resin, a phenol resin, a bismaleimide resin, a polyimide resin, a polyamide resin, and a polyamideimide resin, and
at least a portion of the resin has the functional group capable of reacting with the glycidyl group.

8. The compound according to claim 7,
wherein the resin composition includes the epoxy resin and the phenol resin, and
a ratio of a hydroxyl group equivalent of the phenol resin with respect to an epoxy equivalent of the epoxy resin is 1.0 or more and 1.4 or less.

9. The compound according to claim 7,
wherein the resin composition includes the epoxy resin and a compound having a functional group capable of reacting with an epoxy group.

10. The compound according to claim 9,
wherein the functional group capable of reacting with the epoxy group is an amino group.

11. The compound according to claim 9,
wherein a mass of the compound having the functional group capable of reacting with the epoxy group is 1 part by mass or more and 30 parts by mass or less with respect to 100 parts by mass of the epoxy resin.

12. The compound according to claim 7,
wherein the resin composition includes the epoxy resin, and
at least a portion of the epoxy resin is a naphthalene type epoxy resin having a naphthalene structure.

13. The compound according to claim 12,
wherein the naphthalene type epoxy resin is at least one of a trifunctional epoxy resin and a tetrafunctional epoxy resin.

14. The compound according to claim 6,
wherein a viscosity at 100° C. of the resin composition is 1 Pa·s or more and 50 Pa·s or less,
a viscosity at 50° C. of the resin composition after being heated at 100° C. for 30 minutes is represented by Vf,
a viscosity at 50° C. of the resin composition before being heated at 100° ° C. for 30 minutes is represented by Vi,
Vf is higher than Vi, and
the resin composition is a solid at 25° C.

15. The compound according to claim 6,
wherein a total mass of a plurality of the magnetic particles is represented by Mm,
a total mass of the first silicon compound, the second silicon compound, and the resin composition is represented by Mr, and
Mm/Mr is 94/6 or more and 99/1 or less.

16. The compound according to claim 6,
wherein a plurality of the magnetic particles are at least one kind of permanent magnet selected from a Sm—Fe—N-based magnet and a Nd—Fe—B-based magnet, and
the compound is used for a bonded magnet.

17. The compound according to claim 6,
wherein a plurality of the magnetic particles are at least one kind of soft magnetic material selected from a pure iron and an alloy including iron, and
the compound is used for a dust core.

18. A compact for a bonded magnet,
comprising the compound according to claim 16.

19. A compact for a dust core,
comprising the compound according to claim 17.

20. A bonded magnet,
comprising the compact according to claim 18.

21. A dust core,
comprising the compact according to claim 19.
